(19) United States
(12) Patent Application Publication
(10) Pub. No.: US 2001/0021408 A1
(43) Pub. Date: Sep. 13, 2001

(54) Vegetable salt preparation method and vegetable salt

(76) Inventor: Won-Dae Kim, Gunpo (KR)

Correspondence Address: JACOBSON HOLMAN PLLC, 400 SEVENTH STREET N.W., SUITE 600, WASHINGTON, DC, 20004, US

(21) Appl. No.: 09/788,617

(22) Filed: Feb. 21, 2001

(30) Foreign Application Priority Data
Feb. 22, 2000 (KR) 2000-8485
Nov. 17, 2000 (KR) 2000-68417

(51) Int. Cl. A23L 1/237; A23L 1/20

(52) U.S. Cl. 426/640; 426/615; 426/649

(57) ABSTRACT

There is provided a vegetable salt preparation method which can obtain vegetable salt having a low salinity, a high mineral content and very little heavy metals harmful to the human body. To obtain the vegetable salt, a halophilious plant is gathered and impurities are removed therefrom. Thereafter, it is cleaned and chopped or crushed, and then hydrothermal extraction is performed to obtain an extract. This extract is dried and sequentially passes through the first ashing at 150-250° C. for thirty minutes, the second ashing at 500° C. for two hours or longer and the third ashing at 700° C. for longer than two hours, and then pulverized, to thereby obtain the vegetable salt having uniform granules.

### BACKGROUND OF THE INVENTION

1. Field of the Invention

The present invention relates to a vegetable salt preparation method and vegetable salt, and more particularly, to a vegetable salt preparation method which obtains vegetable salt having a low salinity, a high mineral content and little heavy metal content harmful to the human body from halophilious plants such as salicornia europaea, suaeda japonica, suaeda maritima and aster tripolium.

2. Description of the Related Art

Salt (NaCl) is a typical substance that tastes salty. Sodium is among its components. It is an important positive ion of the human extracellular fluid. It controls the osmotic pressure of body fluids. It is involved in balancing acid and base and helps generate not only the innervation substance but also the stomach acid to make digestive fluid. Sodium also takes part in enzyme activities. Sodium is used as a seasoning for applying salt to food and for improving storage quality because it has a pure salty taste.

Salt is mainly obtained by concentrating seawater. It is divided into bay salt which is made by flowing seawater into a saltern and vaporizing the water with sunlight and wind force and refined salt which is obtained by refining the bay salt. The bay salt contains a component harmful to the human body. It has low salinity, 80-88%, but includes impurities. The refined salt has a salinity of 95-99% and contains components harmful to the human body. It also has little beneficial ingredients.

Meanwhile, salt becomes the cause of various diseases in adult people one of which includes high blood pressure when excessively taken. Thus, organic-acid alkali salt having a salty taste similar to that of salt, for example, organic salt such as disodium malate, diammonium malonate, diammonium sebasate and sodium gluconate, is used as a salt substitute for people having kidney disease, hepatitis liver trouble and high blood pressure. It is also available for those who are required to take a limited amount of salt or use it for the preparation of unsalted soysource.

Furthermore, to reduce the intake of sodium-chloride salt, there has been proposed a method of mixing the sodium chloride with sodium potassium that is an alkali metal salt of the same group of the atomic periodic table. Another method of completely changing the sodium chloride with the sodium potassium has also been proposed. However, people do not prefer the sodium potassium because it leaves a bitter taste after the initial salty taste.

As described above, bay salt contains components harmful to the human body whereas refined salt has little beneficial ingredients like minerals. Organic salt is not preferable in terms of economics because its preparation costs are high. Moreover, with serious environmental contamination in recent years, the preparation of salt using seawater is difficult and consumers do not prefer this kind of salt.

Accordingly, there has been recently proposed a method of mixing refined salt with useful components contained in such food materials as garlic, a balsam extract and a pine, to supply deficient nutritive elements in salt. However, this kind of salt does not contain a sufficient amount of mineral, compared to bay salt, and requires a complicated preparation process. Also, it is distinguished from vegetable salt because it employs refined salt obtained by using seawater.

Due to the previously described problems, it has been impossible to obtain salt having very little heavy metal harmful to the human body and contain satisfactorily sufficient mineral components. Accordingly, the present invention provides a vegetable salt preparation method which obtains salt having a low salinity, a high mineral content and very little harmful heavy metals.

The prepared vegetable salt uses a halophilious plant such as salicornia europaea, suaeda japonica, suaeda maritima and aster tripolium as its material. The halophilious plant has rarely been applied to industrial fields, although it has been used a little in folk remedy. Accordingly, utilization of the halophilious plant as salt is unprecedented.

### SUMMARY OF THE INVENTION

Therefore, the present invention is derived to resolve the disadvantages and problems of the prior art and has an object to provide a vegetable salt preparation method and provide a vegetable salt having a low salinity, a high mineral content and very little heavy metal harmful to the human body.

It is another object of the present invention to provide a method of making vegetable salt easy.

It is still another object of the present invention to provide a method of obtaining vegetable salt from the plant itself.

To accomplish the objects of the present invention, there is provided a vegetable salt preparation method, comprising the steps of: gathering a halophilious plant; removing impurities from the gathered halophilious plant; cleaning the plant from which the impurities are removed and chopping or crushing it; putting the chopped or crushed plant material into water and performing hydrothermal extraction at a predetermined temperature for a predetermined period of time, to obtain an extract; drying the extract; and ashing of the dehydrated material at low and high temperatures by stages.

The method may further include the step of compressing the extract to collect only the juice after the step of obtaining the extract.

The method may further include the step of pulverizing the dehydrated material that has passed through the ashing step, to make the material into uniform granules.

It is preferable that the cleaning of the halophilious plant is performed by using seawater or salt water.

It is preferable that the hydrothermal extraction is maintained at a higher degree than 100° C. for 1-5 hours.

The amount of water used in the hydrothermal extraction step is preferably three times that of the halophilious plant material.

The drying may use lyophilization, spray drying or air heating drying.

The ashing may include: a first ashing step in which the dehydrated material is heated at 150-250° C. for thirty minutes or longer; a second ashing step in which the material that has passed through the first ashing is heated at higher degrees than 500° C. for longer than two hours; and a third ashing step in which the material that has passed through the second ashing is heated at higher degrees than 700° C. for longer than two hours.

The vegetable salt obtained through the aforementioned method has a NaCl content of above 80% weight.

### BRIEF DESCRIPTION OF THE DRAWING

A more complete appreciation of the invention, and many of the attendant advantages thereof, will be readily apparent as the same can be better understood by reference to the following detailed description when considered in conjunction with the accompanying drawing, in which like reference symbols indicate the same or similar components, wherein:

FIG. 1 shows a process of vegetable salt preparation method as set forth in the present invention.

### DETAILED DESCRIPTION OF THE INVENTION

Preferred embodiments of this invention will be explained with reference to the accompanying drawing.

The halophilious plant is the material used in the vegetable salt of the present invention. It is a plant that lives at the ground holding salt. The halophilious plant means a higher plant life living in the seashore, coastal sand dune, inland salty ground, etc. in most cases. Totally, there are 40 species of 16 families of halophilious plants living in Korea. They grow thick in the upper area of silt in the southwest coast. The halophilious plants include salicornia europaea, suaeda japonica, suaeda maritima and aster tripolium which are widely known.

The salicornia europaea among the halophilious plants is an annual plant living in the silt of the west coast of Korea and its general name is “Glasswort”. It has many nodes at its stem, and is cylindrically fleshy and grows 15-20 cm. Its branch branches off once or twice. This salicornia europaea has dark green stems and branches. It grows by absorbing components of seawater (absorbing the components of seawater to be self-purified through metabolism). The salicornia europaea can be found in old books from Japan and China. It is described as a precious plant bringing eternal youth. In view of this fact, it can be presumed that the ancients believed that this plant was very valuable.

The salicornia europaea grows spontaneously in the coastal damp salt area and absorbs seawater to the limit at high tide. At low tide, the sun vaporizes moisture from its stem and branch through photosynthesis, having only various effective components contained in the seawater which remain after the vaporization. The salicornia europaea has characteristics that it contains all components of seawater while being a land plant and has the form and physiology of a solitary plant botanically. Furthermore, it includes a considerably large amount of ash content of at least 33.3%, which is the result of a general component analysis. This is higher than the ash contents of dehydrated seaweeds which are 27.9% for tangle tang, 27.0% for brown seaweed, and 23.4% for ulvaceae, etc. by 5-18%. From this fact, the salicornia europaea is a source of supply of abundant minerals. In fact, contents of Ca, K, Fe and P, which are major minerals, per 100 g of dehydrated salicornia europaea are 550 mg, 2140 mg, 10 mg and 260 mg, respectively. This means that the salicornia europaea has the Ca content of five times that of milk and of three times that of oyster in addition to the Fe content of 10 mg and the vitamin C content of 126 mg.

The salicornia europaea, as described, has been used as a treatment for high blood pressure and low blood pressure in folk remedy and is known to be good for elimination of coprostasis, to make digestion strong and to lower blood glucose levels. That is, the salicornia europaea holds a variety of minerals and enzymes of seawater, the enzymes being contained by a very small amount such as 1 g per 1 ton of seawater. These enzymes go into the intestines and decompose waste matter that is a neutral fat attached onto the wall of the intestines and eliminate it from the system. The salt contained in the salicornia europaea also improves peristalsis motion. In doing so, any coprostasis left in the intestines is eliminated. This salicornia europaea has been used in the folk remedy but it has barely been applied industrially. Accordingly, its application as salt is unprecedented.

The suaeda japonica also called a sea-blite, grows 30-40 cm and becomes green in spring and summer but becomes red in autumn. This suaeda japonica lives in a group in relatively hard muddy areas in the upper portion of an intertidal zone (it is not an area where seawater comes in every day but a zone as high as a level that seawater reaches at the spring tide when lots of water moves) and it requires the seawater components. The suaeda japonica is widely distributed in the silt of the southwest coast of Korea and its sprout may be eaten when its stem is soft in the springtime. The suaeda japonica has been used in folk remedy, similarly to the salicornia europaea, but has not been applied to industrial fields. Accordingly, its application for salt is unprecedented.

The vegetable salt preparation method and vegetable salt according to a preferred embodiment of the invention is explained below in detail with reference to the accompanying drawing.

The vegetable salt according to the present invention is made by drying an extract, that is obtained by removing impurities from a gathered halophilious plant, such as salicornia europaea, suaeda japonica, suaeda maritima and aster tripolium, cleaning the plant and performing hydrothermal extraction, carrying out ashing process for the dried extract and pulverizing it into uniform granules. The vegetable salt contains a NaCl content of above 80% weight, a large amount of essential minerals such as Ca, K, P, Fe, Mg and a minute quantity of various minerals, but hardly has heavy metals like As, Pb, Cd and Hg.

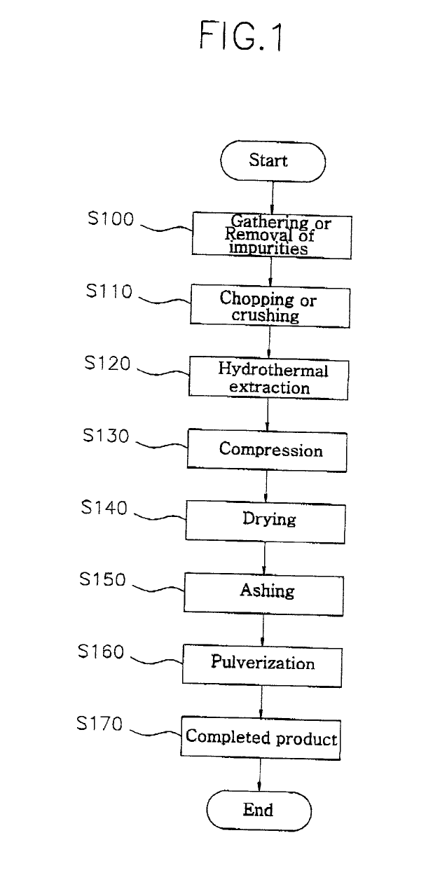

The vegetable salt preparation method of the present invention is described below. FIG. 1 shows a process of the vegetable salt preparation method.

Referring to FIG. 1, the vegetable salt preparation method of the invention includes a step (S100) of gathering a halophilious plant such as salicornia europaea, suaeda japonica, suaeda maritima and aster tripolium, a step (S110) of removing impurities from the halophilious plant, a step (S120) of cleaning the halophilious plant from which the impurities are eliminated, a step (S130) of crushing or chopping the cleaned halophilious plant, a step (S140) of carrying out hydrothermal extraction for the crushed or chopped halophilious plant to obtain an extract, a step (S150) of drying the extract to make it into ashes, and a step (S160) of pulverizing it into uniform granules.

Specifically, the halophilious plant like salicornia europaea, suaeda japonica, suaeda maritima and aster tripolium is gathered (S100) and impurities are removed therefrom (S110). Then, the plant is cleaned by using seawater or salt water twice or three times to eliminate the mud component attached thereto (S120). The halophilious plant may be cleaned by using a general piped in water instead of the seawater or salt water but, in this case, the salinity of the obtained salt may be too low.

After the cleaning, the halophilious plant is chopped or crushed (S130). This is for improving the extraction efficiency in the following hydrothermal extraction step and reducing the extraction time. The chopped or crushed plant is put into a proper amount of water and heated to extract various components including minerals contained in the halophilious plant (S140). Though an extraction temperature is above 100° C. and it is preferably maintained for 1-5 hours, it can be appropriately varied with respect to the crushed or chopped state of the plant and pressure. It is effective that the amount of water is about three times that of the halophilious plant material but a quantity of water capable of maintaining the liquid state must be added until a large amount of components are extracted from the halophilious plant material. This can be determined through repeated experiments.

After the hydrothermal extraction of the halophilious plant material, the extract and juice are put into a filter bag and compressed (S150) to collect only the juice, and then it is dried using a method well-known in the art, for example, lyophilization, spray drying and air heating drying (S160). The obtained dehydrated material is made into ashes through three steps (S170). Specifically, this ashing process includes a first step of heating the dehydrated material at a temperature of 150-250° C. for thirty minutes or longer to make it into ashes, a second step of heating them at a temperature of above 500° C. for more than two hours, and a third step of heating the material at higher than 700° C. for two hours or longer. That is, the material is heated at 150-250° for thirty minutes or longer at the first ashing, heated at higher than 500° C. for more than two hours at the second ashing, and then heated at 700° or higher for two hours or longer at the third ashing, to thereby make the dehydrated material into ashes. The first ashing step is a process for reducing the volume of the halophilious plant material and the second and third steps are carried out for high-temperature burning the material that has been through the first ashing.

Through the ashing process, the vegetable salt of the present invention is finally obtained. This vegetable salt can be eaten as it is or it can be pulverized into uniform granules using a general pulverizer (S180). The extracted vegetable salt is packed through a general packing machine, to be a completed product (S190).

The vegetable salt obtained through the aforementioned preparation method contains a NaCl content of above 80% weight, a large amount of essential minerals such as Ca, K, P, Fe and Mg and a minute quantity of various minerals. However, the vegetable salt barely has any heavy metals like As, Pb, Cd and Hg.

There will be represented results of analysis of the components of the halophilious plant material (salicornia europaea) before the fabrication of the vegetable salt of the invention and the vegetable salt product obtained through the preparation method of the invention. The following tables 1, 2, 3 and 4 show the results of the analysis of the components contained in the salicornia europaea, performed by Korea Food Research Institute. The tables 1, 2 and 3 represent the results of the analysis of nutriments and free amino acid contained in the salicornia europaea powder obtained through lyophilization of salicornia europaea material and pulverization thereof.

TABLE 1
Unit: mg/100 g

| Analysis item | Content | Analysis method |
|---|---|---|
| Vitamin A | Undetected | HPLC |
| Vitamin C | 126 | HPLC |
| K | 2137.2 | |
| Na | 11175.9 | |
| Ca | 549.9 | ICP-AES |
| Fe | 9.7 | |
| P | 259.7 | |

TABLE 2
Unit: mg/100 g

| Analysis item | Content | Test method |
|---|---|---|
| Moisture | 4.4 | Oven drying |
| Total fat | 2.2 | Ether extraction |
| Protein | 10.2 | Kjeldahl method |
| Ash | 33.3 | Ashing |
| Fructose | 0.0 | |
| Glucose | 8.2 | |
| Sucrose | 1.4 | ICP-AES |
| Maltose | 3.9 | |
| Lactose | 0.0 | |

TABLE 3
Unit: mg/100 g

| Composition of amino | | |
|---|---|---|
| acid | Content | Test method |
| Aspartic acid | 1245.0 | HPLC(AccQ-tag) |
| Serine | 539.2 | HPLC(AccQ-tag) |
| Glutamic acid | 1539.9 | HPLC(AccQ-tag) |
| Glycine | 593.1 | HPLC(AccQ-tag) |
| Histidine | 222.6 | HPLC(AccQ-tag) |
| Threonine | 497.8 | HPLC(AccQ-tag) |
| Arginene | 554.1 | HPLC(AccQ-tag) |
| Alanine | 628.3 | HPLC(AccQ-tag) |
| Proline | 530.4 | HPLC(AccQ-tag) |
| Cystein | 0.0 | HPLC(AccQ-tag) |
| Tyrosine | 349.6 | HPLC(AccQ-tag) |
| Valine | 572.7 | HPLC(AccQ-tag) |
| Methionine | 169.8 | HPLC(AccQ-tag) |
| Lysine | 670.6 | HPLC(AccQ-tag) |
| Isoleucine | 478.6 | HPLC(AccQ-tag) |
| Leucine | 775.3 | HPLC(AccQ-tag) |
| Phenylalanine | 542.1 | HPLC(AccQ-tag) |

Table 4 shows the result of the analysis of the mineral components contained in the salicornia europaea powder obtained through lyophilization of salicornia europaea material and pulverization thereof, carried out by Korea Institute of Science and Technology.

TABLE 4
Unit: Weight %

| Component | Content | Analysis method |
|---|---|---|
| Na | 6.27 | AAS |
| Ca | 0.65 | ICP |
| K | 0.90 | AAS |
| Sr | 0.0041 | ICP |
| Mg | 1.03 | ICP |
| B | 0.0054 | ICP |
| HCO3- | 0.49 | WET |
| Cl- | 9.18 | IC |
| Br- | 0.048 | IC |
| SO42- | 2.03 | IC |

Next, there is described an embodiment of the vegetable salt preparation process according to the invention.

The salicornia europaea is gathered and impurities are removed therefrom. Then, it is cleaned twice by using seawater or salt water to eliminate the mud component attached thereto, and chopped or crushed in order to improve the hydrothermal extraction efficiency and shorten the extraction time. Thereafter, after putting a triple amount of water, the prepared salicornia europaea material is added to be heated at 100° C. for more than three hours, thereby extracting a variety of ingredients like minerals contained in the salicornia europaea. This extract is put into the filter bag and compressed to collect the juice. This juice is dried through air heating drying and the obtained dehydrated material is put into a ceramic container. This material sequentially passes through the first ashing at 150-250° C. for thirty minutes, the second ashing at 500° C. for two hours or longer and the third ashing at 700° C. for longer than two hours, and then pulverized, to thereby obtain vegetable salt having uniform granules.

Table 5 shows a result of analysis of the ingredients of the salt product obtained from the salicornia europaea material through the process of the invention, performed by Korea Institute of Science and Technology.

TABLE 5
Unit: Weight %

| Component | Content | Analysis method |
|---|---|---|
| NaCl | 89.2 | AAS |
| Total Cl | 50.8 | WET |
| Moisture | 0.078 | WET |
| SO42- | 0.30 | WET |
| As | Less than 0.00005 | ICP |
| Pb | Less than 0.0002 | AAS |
| Cd | Less than 0.00005 | AAS |
| Hg | Less than | AAS |
| | 0.000001 | |

In case the vegetable salt is obtained through the steps of removing impurities from the gathered halophilious plant, cleaning the plant material, carrying out hydrothermal extraction to obtain an extract, drying the extract and making it into ashes, and pulverizing them, as previously described in the embodiment, it is possible to get the vegetable salt holding very little heavy metals such as As, Pb, Cd and Hg, as shown in table 5.

As described previously, the present invention cleans the halophilious plant, chops it, carries out hydrothermal extraction to obtain an extract, dries it, sequentially performs the first ashing at 150-250° C. for thirty minutes, the second ashing at 500° C. for two hours or longer and the third ashing at 700° C. for longer than two hours for the dried material, and then pulverizes it, to thereby obtain the vegetable salt having uniform granules. By doing so, it is possible to easily obtain the vegetable salt having a low salinity, a high mineral content and very little heavy metals harmful to the body. Furthermore, the present invention provides the method to obtain the vegetable salt with a low salinity and a high mineral content from the halophilious plant such as salicornia europaea, suaeda japonica, suaeda maritima and aster tripolium, so that salt can be obtained from the halophilious plant as well as seawater.

It will be apparent to those skilled in the art that various modifications and variations can be made to the vegetable salt preparation method and vegetable salt of the present invention without departing from the spirit and scope of the invention. The present invention covers the modifications and variations of this invention provided that they come within the scope of the appended claims and their equivalents.

What is claimed is:

1. A vegetable salt preparation method, comprising the steps of:
gathering a halophilious plant;
removing impurities from the gathered halophilious plant;
cleaning the plant from which the impurities are removed and chopping it;
putting the chopped plant material into water and performing hydrothermal extraction at a predetermined temperature for a predetermined period of time, to obtain an extract;
drying the extract; and
ashing of the dehydrated material at low and high temperatures by stages.

2. The vegetable salt preparation method as claimed in claim 1, further comprising the step of compressing the extract, after the step of obtaining the extract, to collect only the juice.

3. The vegetable salt preparation method as claimed in claim 1, further comprising the step of pulverizing the dehydrated material that has passed through the ashing step, to make it into uniform granules.

4. The vegetable salt preparation method as claimed in claim 1, wherein the cleaning of the halophilious plant is performed by using seawater or salt water.

5. The vegetable salt preparation method as claimed in claim 4, wherein the hydrothermal extraction is maintained at a higher degree than 100° C. for 1-5 hours.

6. The vegetable salt preparation method as claimed in claim 5, wherein the amount of water used in the hydrothermal extraction step is three times that of the halophilious plant material.

7. The vegetable salt preparation method as claimed in claim 6, wherein the drying uses lyophilization, spray drying or air heating drying.

8. The vegetable salt preparation method as claimed in claim 7, wherein the ashing comprises:
a first ashing step in which the dehydrated material is heated at 150-250° C. for thirty minutes or longer;
a second ashing step in which the material that has passed through the first ashing is heated at a higher degree than 500° C. for longer than two hours; and
a third ashing step in which the material that has passed through the second ashing is heated at a higher degree than 700° C. for longer than two hours.

9. A vegetable salt comprising:
a halophilious plant having impurities and said impurities being removed by cleaning said plant;
an extract formed from said cleaned halophilious plant by crushing or chopping said plant and performing hydrothermal extraction at a predetermined temperature for a predetermined period of time, said extract being dried to form a dehydrated material and said material being ashed at low and high temperatures by stages to form said salt having a NaCl content of above 80% weight.

10. A vegetable salt preparation method, comprising the steps of:
gathering a halophilious plant;
removing impurities from the gathered halophilious plant;
cleaning the plant from which the impurities are removed and crushing it;
putting the crushed plant material into water and performing hydrothermal extraction at a predetermined temperature for a predetermined period of time, to obtain an extract;
drying the extract; and
ashing of the dehydrated material at low and high temperatures by stages.

11. The vegetable salt preparation method as claimed in claim 10, further comprising the step of compressing the extract, after the step of obtaining the extract, to collect only the juice.

12. The vegetable salt preparation method as claimed in claim 10, further comprising the step of pulverizing the dehydrated material that has passed through the ashing step, to make it into uniform granules.

13. The vegetable salt preparation method as claimed in claim 10, wherein the cleaning of the halophilious plant is performed by using seawater or salt water.

14. The vegetable salt preparation method as claimed in claim 13, wherein the hydrothermal extraction is maintained at a higher degree than 100° C. for 1-5 hours.

15. The vegetable salt preparation method as claimed in claim 14, wherein the amount of water used in the hydrothermal extraction step is three times that of the halophilious plant material.

16. The vegetable salt preparation method as claimed in claim 15, wherein the drying uses lyophilization, spray drying or air heating drying.

17. The vegetable salt preparation method as claimed in claim 16, wherein the ashing comprises:
a first ashing step in which the dehydrated material is heated at 150-250° C. for thirty minutes or longer;
a second ashing step in which the material that has passed through the first ashing is heated at a higher degree than 500° C. for longer than two hours; and
a third ashing step in which the material that has passed through the second ashing is heated at a higher degree than 700° C. for longer than two hours.
